(19) United States
(12) Patent Application Publication
(10) Pub. No.: US 2024/0256357 A1
(43) Pub. Date: Aug. 1, 2024

(54) METHODS, SYSTEMS AND APPARATUS TO PROVIDE A HIGHLY AVAILABLE CLUSTER NETWORK

(71) Applicant: VMware LLC, Palo Alto, CA (US)

(72) Inventors: George Hicken, San Francisco, CA (US); Brian Masao Oki, Palo Alto, CA (US); Abhishek Srivastava, Palo Alto, CA (US); Mark Johnson, Palo Alto, CA (US)

(21) Appl. No.: 18/102,683

(22) Filed: Jan. 27, 2023

(51) Int. Cl. G06F 9/50; H04L 67/1061

(52) U.S. Cl. CPC G06F 9/5077; H04L 67/1068; G06F 2209/505

(57) ABSTRACT

Methods, system, and articles of manufacture are disclosed to provide high availability to a cluster of nodes. Example apparatus disclosed herein are to identify member nodes of a cluster, determine whether an instance of an infrastructure supervisor is operating on any of the nodes, when an infrastructure supervisor is determined to not be operating, instantiate an infrastructure supervisor, and broadcast a discovery message to other nodes.

### FIELD OF THE DISCLOSURE

This disclosure relates generally to network architecture and, more particularly, to methods and apparatus to provide a highly available cluster network architecture.

### BACKGROUND

As cloud computing matures, cloud computing service providers offer customers more advanced capabilities (including software as a service, function as a service, etc.). The infrastructure to support such services properly has to be robust by a myriad of measures including reliability, consistency, security, latency, optimization, stability, etc. Thus, cloud computing infrastructure continues to be a main focus of cloud computing service providers.

### BRIEF DESCRIPTION OF THE DRAWINGS

FIG. 1 is a block diagram of a cluster of physical servers (hosts) that includes an example infravisor system in accordance with the teachings herein.

FIG. 2 is a block diagram of an example infravisor runtime in an infravisor overlay network between three of the hosts of FIG. 1.

FIG. 3 is a block diagram of an example set of data connectivity paths between the infravisor instances on three of the hosts of FIG. 1.

FIGS. 4A-4E illustrate an infravisor bootstrap workflow.

FIGS. 5A-5F illustrate an example manner in which hosts are removed from and added to a cluster.

FIG. 6 is a flowchart representative of example machine readable instructions and/or example operations that may be executed by example processor circuitry to implement the infravisor runtime illustrated in the FIGS. 1, 2, 3, 4A-4E, 5A-5F.

FIG. 7 is a block diagram of an example processing platform including processor circuitry structured to execute the example machine readable instructions and/or the example operations of FIG. 6 to implement the infravisor runtime of FIGS. 1, 2, 3, 4A-4E, and 5A-5F.

FIG. 8 is a block diagram of an example implementation of the processor circuitry of FIG. 7.

FIG. 9 is a block diagram of another example implementation of the processor circuitry of FIG. 7.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Robust computer networking infrastructure is needed to support the advanced capabilities being offered by cloud computing network services. Although robust operation is the goal, for a variety of reasons, host failures occasionally occur. In today's cloud computing networks, when a failed host is operating as a part of cluster of cloud computing devices, and the loss of the host does not cause a loss of quorum, cloud computing network providers have devised techniques by which the remaining hosts included in the cluster step-in to perform the services that were previously on the lost host. In such circumstances, a customer using the host at the time of the failure is often not even aware that such a failure occurred. In contrast, when the failure of the host causes quorum of the cluster to be lost, the entire cluster becomes unavailable (e.g., stops operating). In such instances, human intervention is required to bring the cluster back to an operational state.

Computer networks often include clusters of computers (which may be implemented as virtual machines running on a physical device) that are networked together to operate as a single computer/computer system. Each such cluster has an assigned number of hosts (also referred to herein as members). The number of hosts included in a cluster is often fluid as different ones of the hosts fail, are added, are brought offline, etc. for any of a variety of reasons. For example, in some instances, a network administrator removes, adds and/or swaps hosts from a cluster (via an administrator interface) as needed to support the changing needs of the client/customer (e.g., the client/customer paying to use the computing cluster). Cluster quorum is defined as the minimum number of members of an assembly or society (in this instance cluster members) that must be present to make any cluster decisions valid. Thus, a quorum is met when a specified number of hosts included in a cluster are operating and communicating. The specified number of hosts is typically one more than a majority of the number of hosts present in the cluster at any given time. In some cases, a single physical server may support multiple virtual machines (also referred to as nodes). In such cases, the cluster quorum defines a specified number of the nodes that are to be operating at any given time. In some cases, a cluster may include different virtual machines/nodes operating on different physical hosts.

In the context of a standard Kubernetes cluster, when quorum is met there are enough cluster members (and operating) present such that changes can be made. In contrast, in a Kubernetes cluster, if quorum is lost, the cluster becomes read-only.

The methods, systems, and apparatus disclosed herein provide an infrastructure supervisor for a computing cluster. The disclosed infrastructure supervisor provides a cluster runtime environment for network infrastructure logic. In some examples, the infravisor specifies a desired state for infrastructure services and ensures that such services are always running and functional in an autonomous network computing cluster with minimal administrator intervention. In some examples, the infrastructure supervisor provides high-availability for infrastructure software, even in the event that cluster quorum is lost due to loss of hosts/members or network partition. In some examples, the disclosed infrastructure supervisor (also referred to herein as an infravisor) runs infrastructure management software and provides infrastructure lifecycle management.

The primary service examples provided herein are infrastructure services, however, there is no fundamental limitation around workload type. In fact, customer services can be supported by (run on top of) infravisor as in a normal Kubemetes cluster provided constraints identified herein are adopted.

In some examples, when a cluster host or a cluster node (both are also referred to herein as a cluster member), loses connectivity with the cluster for any reason, and the loss of that cluster member causes quorum to be lost (i.e., quorum is no longer met), the infravisor disclosed herein uses information (described in detail below) stored on one or more of remaining cluster members to keep the cluster operational. In such examples, the cluster remains operational until a time at which an administrator takes any steps needed to regain quorum. As such, users operating service workloads on the cluster may continue to rely on the cluster for such services without having to wait until a system administrator is able to intervene and reconfigure the cluster as needed to regain cluster quorum.

In some examples, the infravisor operates on a Kubernetes-like cluster (referred to herein as an infravisor cluster). The infravisor cluster is described as Kubernetes-like because, although many of the aspects of a standard Kubernetes cluster are employed by the cluster, the infravisor cluster does not fail when quorum is lost (as happens when a Kubernetes cluster loses quorum.

For background purposes, a Kubernetes cluster consists of a set of worker machines, called nodes, that run containerized applications. A Kubernetes worker node hosts pods that embody the components of an application workload. A pod consists of one or more containers and some additional configuration information. A Kubemetes control plane manages the worker node(s) and the other pods in the Kubernetes cluster. In production environments, the Kubernetes control plane usually runs across multiple computers and a cluster usually runs multiple nodes. In operation, a Kubernetes cluster control plane, provides fault-tolerance and high availability.

In some examples, the infravisor is implemented using a spherelet. The spherelet operates as an extension to a Kubernetes control plane. In some examples, the spherelet operates inside container runtime execution (CRX) based pods (e.g., pods running as virtual machines) and communicates with the container runtime using a spherelet agent. In some examples, the spherelet agent provides functionality that is usually associated with a Kubemetes-based pod, including performing health checks, mounting storage, setting up networking, controlling states of the containers inside the pod, and providing an interactive endpoint to a Kubernetes command-line tool referred to as Kubectl. The spherelet agent is linked with libcontainer which provides a native Go implementation by which the spherelet agent can launch new containers with namespaces, cgroups, capabilities and filesystem access controls.

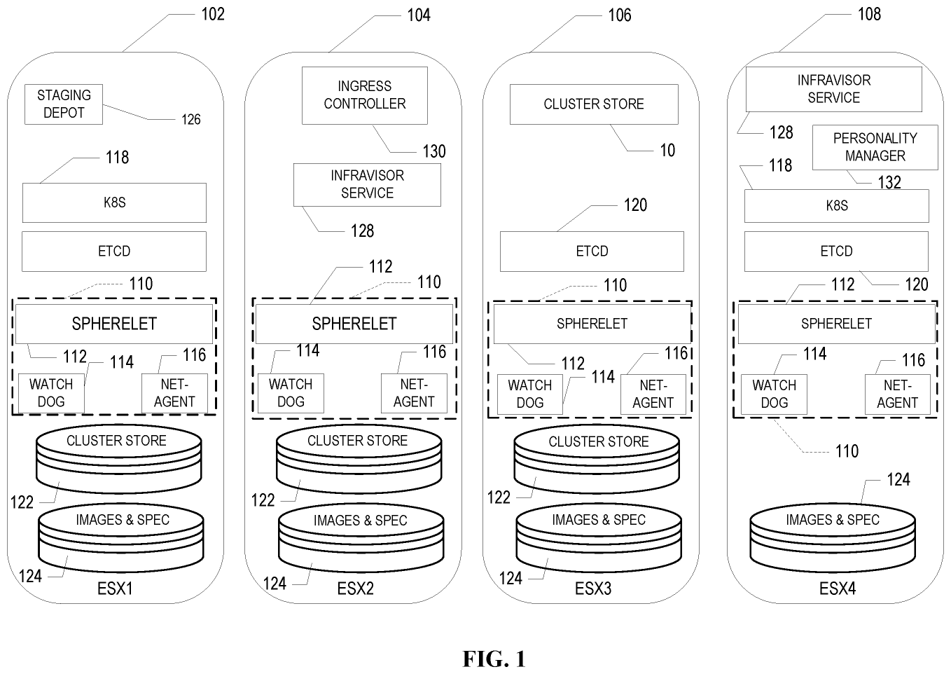

FIG. 1 is a block diagram of a cluster of hosts (host1 102, host2 104, host3 106, host4 108) including a set of example infravisors 110. In some examples, the hosts are implemented using VMware's ESXi server. An ESXi server is installed on a physical host and runs on bare-metal (e.g., hardware) without an underlying operating system. The ESXi server instantiates one or more virtual machines that run as pods. Component of the infravisor 110 include an example spherelet 112, an example watchdog 114, and an example net-agent 116 that can all be implemented as ESXi components. In some examples, Kubernetes pods (referred to as k8s) 118 and an etcd storage 120 (a Kubernetes storage, also referred to as an “etcd”) are included on the host1 102 and the host4 108. In some examples, an example cluster store 122 is included in a subset of the hosts (e.g., the host1 102, the host2 104, and the host3 106) and example images and specifications storage 124 are included in all of the hosts (the host1 102, the host2 104, the host3 108, and the host4 110). In addition, an example staging depot 126 is included in the host1 102, an infravisor service 128 (in this example an example cluster control plane (CCP) service) is included in the host2 104 and the host 4 108, an ingress controller 130 is included in the host2 104, an example personality manager (Pman) 132 is included in the host4 108, and an example and cluster store replica 134 is included in the host3 106.

In the block diagram of FIG. 1, the infravisor 110 perform two discrete groups of functions. A first such group of functions includes: 1) infravisor pod lifecycle management, 2) infravisor network overly management, and 3) infravisor bootstrap and monitoring. In some examples, the first group of functions are performed by the example spherelet, watch dog and net-agent and can be implemented using ESX (or ESXi) daemons (also referred to as an infravisor agent(s)). In some examples, the example spherelet performs lifecycle management for the components of the infravisor 110, the example net-agent performs infravisor network overlay management, and the example watch dog performs infravisor bootstrap and monitoring functions.

A second group of functions is a set of base service images that provide function as an application interface (API) access, desired state controllers and an execution environment. In some examples, references to a version of the infravisor service images and a version of the infravisor runtime images are stored in one or more example k8s 10. In some examples, k8s also identify parameters to be used to customize the behavior of the infravisor runtime images and infravisor service images. The stored references identify places at which the images can be found within the example images and specification storages 10. The examples infravisor spherelet accesses the k8s to determine where the infravisor services and infravisor runtime images are stored in the images and specification storage. The spherelet then executes a set of binaries included in the images to turn the spherelet into a running pod that provides the infravisor runtime and the infravisor services.

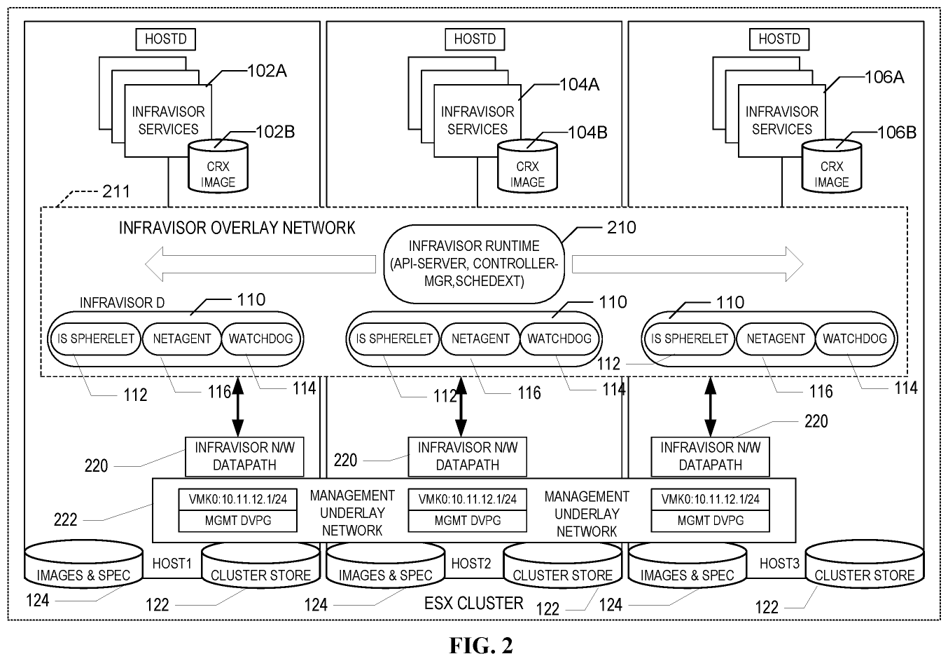

In some examples, the example spherelet is included in an ESX host base image and launches pods (or containers) as directed by an example infravisor runtime API server described in connection with FIG. 2 below. In some examples, the runtime API server is implemented as a cache in the ConfigStore (an ESXi component). In some examples, the spherelet manifests in an ESXi filesystem directory based on images installed to locations on an ESXi filesystem. The filesystem though not explicitly shown in FIG. 1 is represented by the example “Images & Specification” storage (which indicates that the filesystem persisted). In some examples, the Specifications stored in the images and specification storage encompasses the manifests that spherelet processes. The images and specifications storage can be implemented using a ConfigStore (a standard ESXi component) and an OS-DATA store (an ESX system partition, also used for logging, core-dumps, etc). The images in the filesystem provide the physical hosts (e.g., host1, host2, host3, host4) with the information needed to bring up (instantiate) a single node infravisor cluster.

As illustrated in FIG. 1, the cluster store is only on three of the four hosts (e.g., host1, host2, host3, host4), while the spec and images are replicated on all host1, host2, host3 and host4. Thus, for example, if a service such as a dynamic resource scheduling (DRS) service, the same service is also installed onto every one of the hosts on the cluster (in the example of FIG. 1, a four host cluster). The service installation includes installing the binaries needed to support the DRS service and includes the specification for the DRS service. The specification indicates how the service is to be run, identifies inputs to be used with the service, and provides a configuration for the binaries of the service. As a result, if a host of the cluster that is providing the DRS service fails, and that failure causes quorum to be lost, one of the remaining, active hosts (e.g., the hosts of the cluster that are still operating) can instantiate the DRS service despite quorum being lost. As a result, the loss of quorum does not result in complete cluster failure (as occurs in a standard Kubernetes configuration

Initially, Cluster Store was created to store information about cluster state, such as membership, directly on the hosts in a cluster and provide distributed consistency. Cluster Store is backed by etcd instances that run directly on the host (e.g., implemented as an ESXi) as user-world daemons. In the event of a virtual control center losing cluster state, the Cluster Store allows it to rebuild that state reliably. Cluster Store depends on a persistent quorum and does not have the infravisor ephemeral quorum behavior that allows for automation recreation under host failure.

In some examples, a service such as the DRS service is implemented by a vSphere Installation Bundle (VIB). A VIB is a collection of files packaged into a single archive to facilitate distribution of the package. A VIB includes a file archive, an XML descriptor file, and a signature file. The file archive portion of a VIB, also referred to as the VIB payload, contains the files that are used to enable the VIB to provide a desired service. VIBs are added to a host by adding an image of the VIB to the host image. Additionally, the files in a VIB payload are installed on the host.

In some examples, the example infravisor cluster experiences a relatively low rate of chum thereby allowing a change in the way a desired state update occurs. For example, instead of using etcd (as used for relatively high performance cluster consistent changes) to perform desired state changes, infravisor 110 deploys desired state changes via a rolling VIB install to the ESX hosts. Changing where the desired state is persisted allows the k8s cluster to be lost (or discarded) when quorum is lost without reducing the ability for infravisor 110 to operate.

In some examples, the XML descriptor file describes the contents of the VIB and includes information indicating: 1) any requirements to be met when installing the VIB, 2) any dependencies associated with the VIB, 3) any compatibility issues that may occur when the VIB is used, and 4) whether the VIB can be installed without rebooting of the host on which the VIB is to be installed. The signature file portion of the VIB is an electronic signature used to verify the level of trust associated with the VIB. The acceptance level (of trust) helps protect the integrity of the VIB. In addition, the signature file identifies a creator of the VIB, and an amount of testing and verification to which the VIB has been subjected.

In some examples, the example watch dog ensures that the infravisor runtime pods (etcd and Kubemetes) are running within a desired partition P and that the cluster desired state for services is applied to that Kubernetes instance. A network partition will almost always cause a quorum loss in one of the partitions, assuming the partition is on a failure domain boundary because the quorum should be deliberately spread across failure domains as a standard best practice. Thus, an odd number of instances is always used to meet a quorum so that there an even divide does not occur in the event of a two way split of a cluster.

Typically, one of the partitions becomes non-functional when quorum loss occurs. In the case of the infravisor 110, a new infravisor runtime is created in the partition and services are reinstalled. Once the partition is healed, the two infravisor runtimes (one from the partition where quorum continued, and one where it was lost) are collapsed back into a single instance.

If the infravisor runtime is not live, watchdog will bootstrap a new instance of infravisor runtime, populate the new instance of infravisor runtime with a desired state of the cluster, and pivot (also referred to as handover or handoff) the infravisor runtime to be self-hosting.

To perform this bootstrap operation, the watchdog, along with other watchdogs residing within the partition, select one of the hosts of the cluster on which to bootstrap. The watchdogs then uses net-agent to configure NodePorts and ClusterIPs on their local hosts so that traffic from the etcd and Kubernetes infravisor runtime pods flows to the selected one of the cluster hosts. The watch dog residing on the selected one of the hosts instructs the spherelet on that same host to launch an etcd pod and a Kubernetes pod to instantiate the infravisor runtime. The infravisor runtime will be bootstrapped by a watchdog, in this manner, any time watchdog detects the absence of a functional infravisor runtime within its partition. After bootstrap, the infravisor runtime will pivot to self-hosting and scale itself as dictated by configuration for availability vs footprint.

In some examples, an infravisor runtime can be present in any partition of the cluster and pods corresponding to the infravisor runtime may run separately for isolation purposes or in a consolidated fashion to achieve footprint reduction, as desired. As described in greater detail below, the cluster runtime state is ephemeral and can be recreated as necessary. In contrast, a cluster-scoped persistent state is stored in Cluster Store. The infravisor runtime environment also includes control plane pods, such as, for example, as API server, a kube-scheduler, a kube-controller-manager, a scheduler-extender, and a security controller (which can be implemented as a SPIRE controller). Further, the infravisor runtime includes a security server (which can be implemented as a SPIRE server). The security server provides a trust framework between services hosted by the infravisor runtime.

In some examples, the infravisor 110 is packaged with the host base image: Thus, the infravisor control plane elements are packaged with the base host image. Providing the infravisor 110 with the host base image allows for treating the infravisor control plane as a fundamental building block that can be brought up without dependencies on other control planes (e.g., services control planes). In some examples the host system data store is large enough to store images and runtime artifacts (e.g., swap files) for infravisor core components, as well as diagnostics for the infravisor 110, the non-infravisor services, and the host. Thus, in some examples, the image and specification store is implemented using the host system partition. In this instance, a host system partition refers to a storage partition, which is a deliberate subdivision of persistent storage such as a hard drive. This type of partitions is unrelated to the partitions referenced in the context of infravisor runtime and quorums which are network partitions and result from failures.

In some examples, a version of the member list of the cluster, although potentially stale, is stored locally on each host and can be leveraged in recovery paths without requiring access to the Cluster Store. Additionally, in some examples, the participating hosts of the cluster can communicate over a management network to provide the hosts the ability to reach consensus on cluster scoped data/services. Generally, the infravisor control plane is not responsible for cluster scoped persistent data for services, as such services are managed by the example cluster store.

In some examples, the Image & Specification repository for core infravisor services are stored in the host data store partition and are initially seeded from host install media. Subsequently, the Image and Specification repository is managed by the example personality manager. The images are for infravisor services, with the Specifications being for the pods and context such as ConfigMaps and Services. In some examples, the specifications are ingested from an operating system data (OS-DATA) store as part of the infravisor bootstrap process and installed into the resulting cluster to be realized in a standard Kubernetes fashion using the provided images. In some examples the infravisor components run directly from the OS-DATA store such that runtime artifacts including virtual machine swap files and ephemeral virtual machine disks will be placed in the host data store as well. By running the infravisor 110 directly from the operating system data store, infravisor 110 is able to come up (e.g., instantiate) prior to any datastore configuration and, therefore, the infravisor 110 is able to run in the event of catastrophic storage misconfiguration.

In some examples, the Ingress circuitry allows a service running on the cluster to be accessed by a service running outside the cluster. In some examples, the ingress circuitry can be implemented using Load Balancer circuitry and a load balancer controller. The egress circuitry exposes services running outside of the cluster to services running on the cluster. The infravisor services and components are use a cluster network by all hosts in included in the cluster communicate. In some examples, a ServiceIP/and a ClusterIP are virtual IPs on the cluster network that provide access to running replicas of a service. In some examples, a management network is a collection of virtual machine disk ports in the cluster that represent endpoints for hosts (e.g., ESXi hosts) and management traffic. The example net-agent monitors the cluster and performs the actions needed to set up the Cluster Network and the ServiceIP routing. The UserWorlds Process is a daemon that runs on the hosts ESX in a kernel operating system. User world is not intended as a general-purpose mechanism to run arbitrary software applications but instead provides enough of a framework for processes that need to run in a hypervisor environment.

Spherelet is a local per-host controller that monitors the infravisor runtime and realizes any pods scheduled to that host. Lastly, the watchdog is a local agent that monitors and reacts to the state of the infravisor control plane present in the cluster. In some examples, to perform the monitoring, the watchdog checks for a functional etcd and Kubemetes apiserver which are the foundational components of the infravisor runtime. If those aren't functional, then watchdog will act as described herein.

In some examples, the infravisor runtime environment will support upstream Kubernetes constructs. In some examples, the infravisor 110 may operate using container runtime execution (CRX) based pods (e.g., pods running as virtual machines), Deployments, DaemonSets, StatefulSets, ReplicaSets, etc. In some examples, the infravisor 110 provides infrastructure services including Cluster-IP, NodePort (accessible via the hosts directly, but not via the hosts' management IP addresses), ConfigMaps and Secrets (likely read-only via apiserver). As described above and below, the infravisor 110 operates using Custom Resource Definitions, an egress to hosts thereby allowing infravisor services access to host services, an overlay network between infravisor pods and services, persistent storage (CNS), an ingress service to expose the cluster control plane and other services via a singular stable IP address, a depot service to provide a staging location for a personality manager content. In some examples, the personality manager content is not needed if CCP and personality manager are embedded in the host install image.

In some examples, the staging depot, the k8s and the etcds, the ingress controller, the CCP, the Cluster Store, and the personality manager are implemented using CRX, whereas the other components illustrated in FIG. 1 are implemented using ESX daemons. The etcd used by Kubernetes for runtime data is separate from the Cluster Store used for service data due to different usage and persistence criteria.

In a standard Kubernetes environment, the etcd used for the runtime state is the source of truth of the cluster content. (The etcd is a consistent and highly-available key value store used as Kubemetes backing store for all cluster data.) However, for the infravisor 110 that source-of-truth is composited from Personality Manager and Cluster Store; installed images and specifications from PMan, with more dynamic cluster and service configuration from Cluster Store. The separation allows the Kubernetes cluster to be rebuilt from scratch automatically which, coupled with sharding mechanisms, can keep shard aware services functioning under partitioning. In some examples, the roles are consolidated into a single etcd.

Sharding is the action of dividing NSX Controller workloads into different shards so that each NSX Controller instance has an equal portion of the work. All services where a failure to tolerate value (FTT) is satisfied will be available in partitions of any size as long as the service is appropriately authored to handle functioning in such a scenario. The infravisor 110 supports recovery from hard Cluster Store quorum loss without loss of cluster scoped configuration.

In some examples, a single, persistent etcd instance is used for the infrastructure. In addition, the cluster store and infravisor 110 leverage that same etcd instance. In some examples, a single consistency domain is used for both the Cluster Store and the infravisor 110 and the service state is persisted only in custom resource definitions (CRDs). Services running on top of the infravisor 110 only persist data as CRDs, any other runtime state in the infravisor etcd will be considered ephemeral (as before) and may be thrown away during version upgrades. In some examples, the CRDs are owned by the services themselves and are persisted.

In general, some services will require some cluster-consistent configuration. In those instances, the configuration is determined during initial install, and is cached locally on each host. Thus such services can be recreated in partitions provided that there is a ClusterStore quorum during the initial installation.

In some examples, services that run as UserWorlds perform bootstrapping of the infravisor network. In some such examples, the UserWorlds services start/initiate the spherelet and the control plane, and set up the overlay network.

In some examples, the infravisor runtime can undergo the usual types of failure scenarios as are potentially possible with a distributed consensus based system. The infravisor etcd will be strongly consistent. In some examples, the infravisor 110 will report failure modes back to a system/cluster administrator, allowing the system/cluster administrator to intervene and remediate the issue if necessary.

In some examples, any network partitioning event in the infravisor control plane results in the creation of a minority and majority partition. The services running in the minority partition will continue to run as before and new services can be started/stopped/changed in the majority partition. Once the partition heals, the minority partition can re-join the cluster and replay any transitions that occurred during the absence of the minority. In some examples, an administrator will be able to forcefully intervene and initialize a new infravisor cluster in the minority partition, if necessary.

FIG. 2 is a block diagram of an example infravisor runtime instance (also referred to as infravisor runtime) 210 operating within an infravisor overlay network 211 in connection with a subset of the hosts of FIG. 1 (e.g., the host1 102, the host2 104, the host3 106). In some examples, each of the hosts is a hostd. As shown in FIG. 2, the hosts (e.g., the host1, the host2, the host3) can be configured to include different circuitry/components.

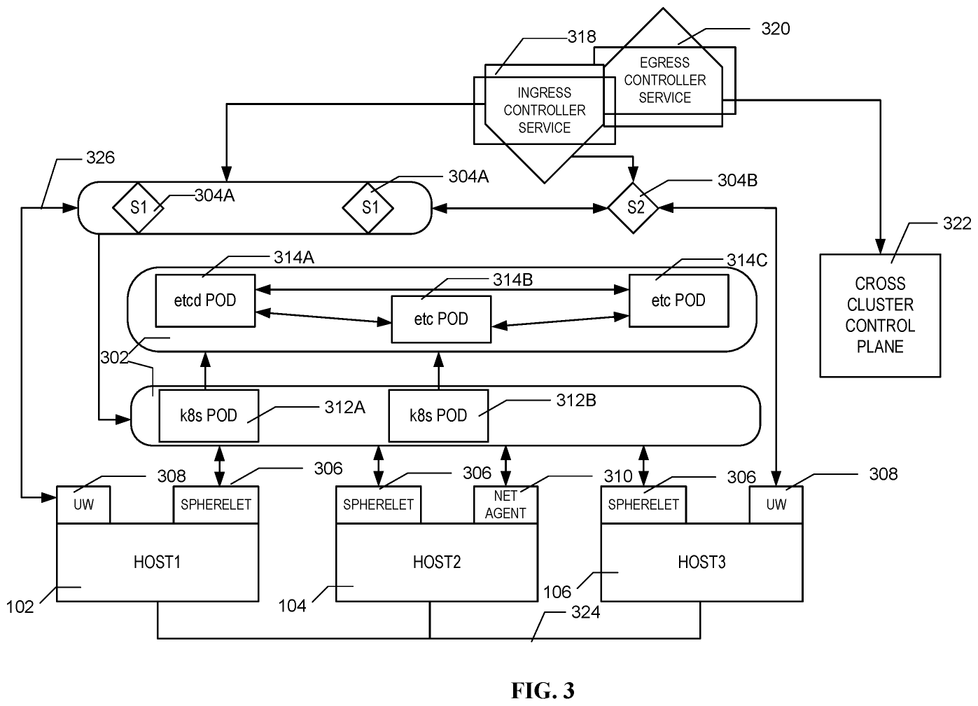

In some examples, the example infravisor runtime instance 210 includes an example API-server, an example controller-mgr and an example schedext. Infrasvisor services 102A, 104A, 106A operate on top of the infravisor overlay network 211 and the components of the infravisor 111410 (see also FIG. 1) (e.g., the IS spherelet 112, the watchdog 114, and the net-agent 116) associated with each host infravisor 110 and infravisor services 102A, 104A, 106A (associated with corresponding CRX image stores 102B, 104B, and 106B) communicate among each other via an infravisor network datapath 220 sitting on top of a management underlay network 222. In some examples, the infravisor 110 of the host1 102 is an infravisord host. In the example set of hosts of FIG. 3, each of the hosts (e.g., the host1 102, the host2 104, the host3 106) include an example cluster store 122, and an example images and specifications storage 124.

As used herein, the term “service” can refer (in most instances) to any logic deployed as pods and managed by the infravisor daemon. However, other services are also described herein. Such services include a network grouping construct backed by zero or more pods. ClusterIP is one such example service. The example net-agent primarily monitors this type of Service for programming the network datapath (e.g., mapping a network Service to a specific set of pods).

FIG. 3 is a block diagram of three of the hosts (e.g., host1 102, host2 104, host3 106) of FIG. 1 coupled via various types of connective paths. As described further below, the types of connective paths allow an infravisor control plane 302 and infravisor services (e.g., a first service S1 304A and a second service S2 304B) to operate in the manner described herein. In some examples, the infravisor control plane 302 and the services S1 and S1 304A/B on top of it run within a direct booted CRX virtual machine able to communicate with one another across the hosts (e.g., host1 102, host2 104, host3 106). In the block diagram of FIG. 2, the hosts are each running a spherelet 306, two of the hosts are additionally running UserWorlds (UW) 308 processes and another of the hosts is additionally running a net-agent 310. An example Cluster IP service 309 includes two k8s pods 312A, 312B, three etcd pods 314A, 314B, 314C, a first of the infravisor services S1 314 and a second service S2 316. Additionally, an ingress and egress controller service 318/320 provides access between the hosts belonging to a different cluster (via a cluster control plane 322 and the services (e.g., service S1 304A and service S2 304B) associated with the cluster of hosts (the host1 102, the host2 104, and the host 3 106). As illustrated, the hosts are connected to each other via a Management Network underlay 324 which is set up prior to initialization of the infravisor control plane.

In some examples, each of the spherelets 306 connects to the control plane 302 to register its corresponding host as a Kubernetes nodes that can schedule services on itself. The connectivity between spherelet and the control plane is bidirectional so that the spherelet can monitor the control plane, and to allow the control plane to run diagnostic and observability tools (e.g., kubectl logs, kubectl exec, etc.). Both the control plane pods (e.g., the k8s pods 312A and 312B) and the services S1 304A and S2 304B communicate with each other via the cluster overlay network 302 which is illustrated in part by the arrows coupling the etc pods 314A, 314B, 314C and the k8s pods 312A and 312B. Likewise, the UserWorlds processes running on the hosts (e.g., the host1 102, the host2 104, and the host3 106) are able to communicate with the services running in the cluster (e.g., the first service S1 and/or the second service S2) via the connective coupling 326.

In the event that the infravisor 110 is to provide custom resource design (CRD) support to one or more of the infravisor services, CRs are persisted in the Cluster Store, with version isolation provided by a Kine style shim or direct modification of k8s storage interface implementation. In some examples, the Cluster Store is implemented as an infravisor service (crx) and in some examples, the Cluster Store is implemented as a daemon of one of the hosts (when implemented as an ESX server). In some examples, the infravisor 110 uses a ClusterIP mechanisms for proxy behavior and in some examples, the infravisor 110 uses alternative means including, having a dedicated ClusterStore proxy that can direct traffic to a ClusterStore replica, using a client-side list of replica IPs that can be used in a round-robin fashion, or there can be attempt to access every host in the membership list to discover which have replicas, then repeat if a replica is lost or moves. In some examples, each of the infravisor pods (and the CRX) is assigned a unique IP from a private CIDR(s).

As used herein, the term “service” can refer (in most instances) to any logic deployed as pods and managed by the infravisor daemon. However, other services are also described herein. Such services include a network grouping construct backed by zero or more pods. ClusterIP is one such example service. The example net-agent primarily monitors this type of Service for programming the network datapath (e.g., mapping a network Service to a specific set of pods).

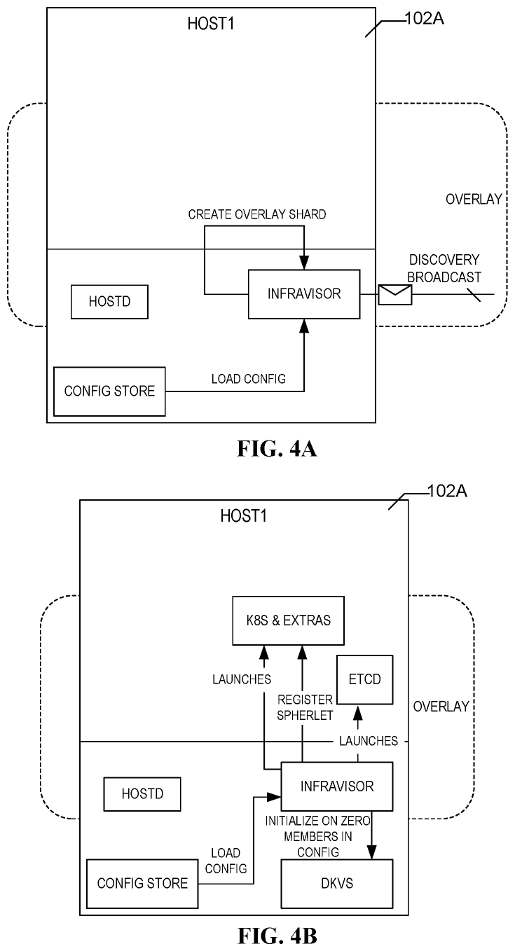

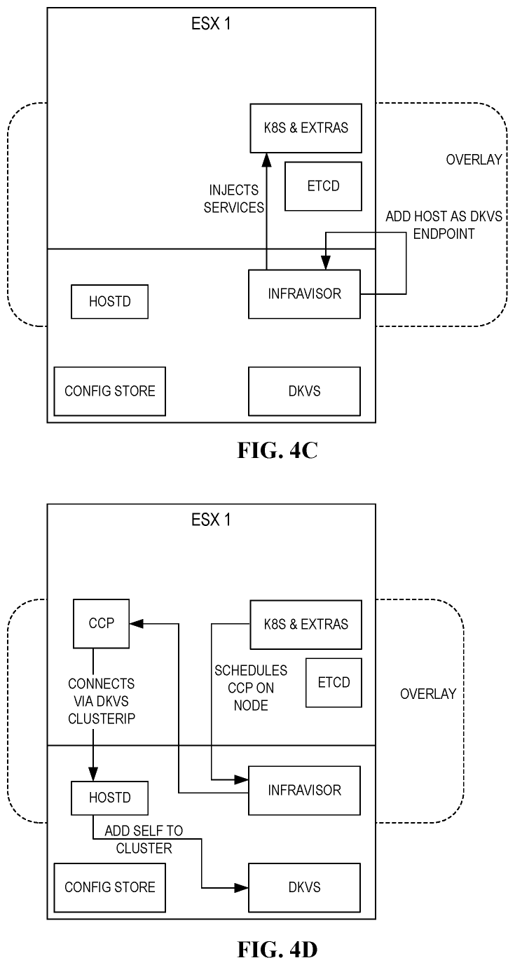

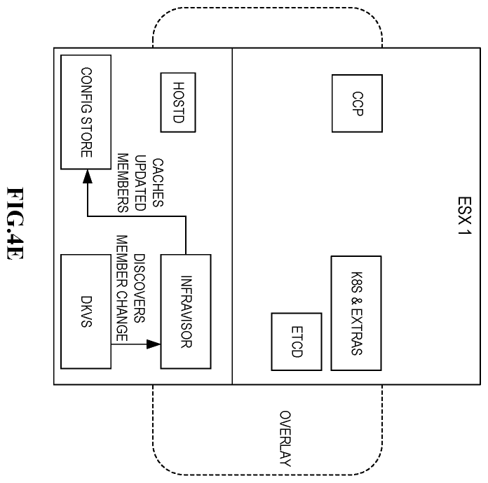

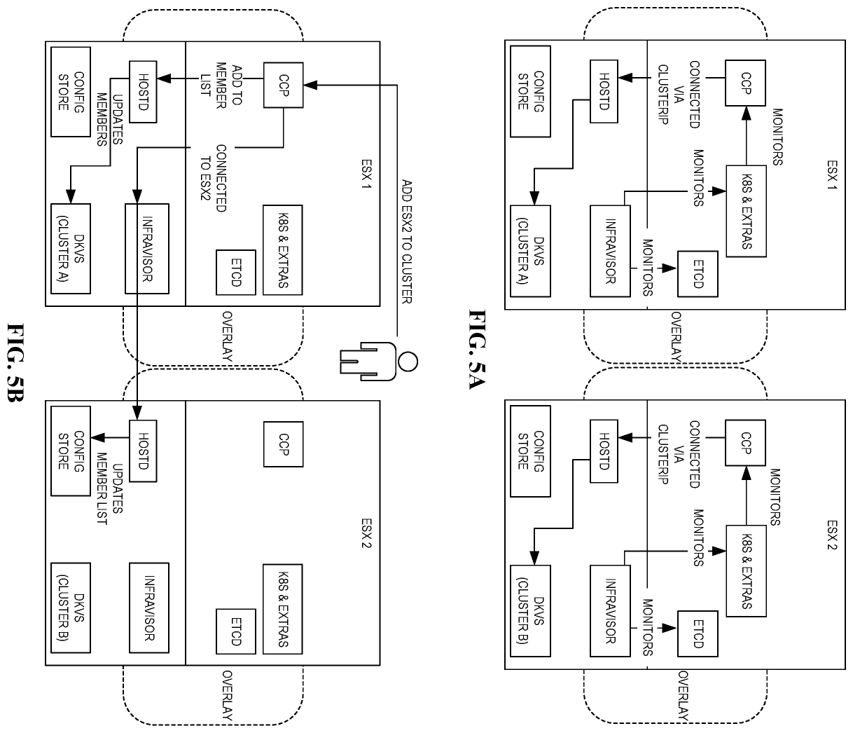

FIGS. 4A-4E are block diagrams of a host (e.g., the host1 102 of FIG. 1 implemented using ESX) performing an infravisor bootstrap workflow. In some examples (as depicted in FIG. 4A), the bootstrap workflow includes initializing the overlay network on the host and discovering the rest of the cluster. In some such examples, initializing and discovering can include, setting up shard assignments and broadcasting a discovery message on the overlay network. Setting up shard assignments includes assigning a shard to itself from the overlay range. When the bootstrap is performed during a reboot operation, the infravisor 110 loads the overlay shard-to-host assignments from the example ConfigStore. The host1 102 of FIG. 4A includes the ConfigStore, an example infravisor 110, an example hostd, and an example network overlay.

When no hosts (other than the local host1) are cached as cluster members in ConfigStore, the infravisor overlay spans only the single host such that broadcasting the discovery message is not necessary. In a configuration in which multiple other hosts are present in the cluster, a discovery message broadcast to the other hosts of the cluster includes a claim to bootstrap. Responses to the claim to bootstrap can be accepted or rejected. In some examples, no reply is treated as an acceptance. In some examples, a rejection includes information identifying the responding host as having a superior claim to bootstrap.

In some examples (as depicted in FIG. 4B), the bootstrap workflow includes instantiating the infravisor runtime at the ESX1 host. This portion of the workflow occurs at the ESX1 host when no other cluster members are present on the cluster, or the ESX1 host wins the vote to instantiate the infravisor runtime. In some examples, instantiation of the infravisor runtime includes configuring a temporary NodePorts service for the etcd and a control plane to point at the host ESX1. In addition, other cluster member host nodes will operate to configure temporary NodePorts pointing at the winning host (e.g., the ESX1 host). Next, the ESX1 host starts a single instance each of the etcd pod and the control plane pods and registers with the control plane as a spherelet. In some examples, registering with the control plane as a spherelet includes labeling the ESX1 node with available image versions. In examples in which a reboot action has not occurred but rather the hosts are being newly installed, the infravisor 110 initializes a new distributed key value storage (referred to as the Cluster Store) provided that no other hosts are cached as cluster members in the ConfigStore. The hostd is the primary control plane for the hosts (e.g., the host1 102, the host2 104, the host3, 106, the host4 108 when implemented using ESXi) and provides an API by which the example hosts are configured, and the example virtual machines (VMs) are created, etc. A hostd is present in all of the hosts of FIG. 4A-4E (though not shown).

In some examples (as depicted in FIG. 4C), the bootstrap workflow includes setting up the cluster for use. In some examples, setting up the cluster includes retrieving service configurations from the ConfigStore (host personality) and binding ClusterIPs and StatefulSet pod IP addresses. When the workflow is part of an initial set up of a network the infravisor 110 allocates new IPs using the Cluster Store for consistency. When the workflow results from a reboot, the infravisor 110 loads assignments from the ConfigStore and injects service configurations from the ConfigStore (host personality). When there are multiple cluster members, specific configurations to be injected are selected by consensus via the etcd pod. Next, NetAgent uses the API server to configure NodePorts and ClusterIPs for the infrastructure services to be supported.

In some examples, (as depicted in FIG. 4D), the bootstrap workflow includes realizing service specifications. The infravisor 110 realizes the services specifications by scheduling a service pod on the host. When multiple hosts are included in the cluster membership, the infravisor 110 schedules the service pod (e.g., a CCP pod, a DRS pod, etc.) to a host with the proper service image version. The service pod then connects to the Cluster Store via the ClusterIP address service and obtains cluster configuration information. If the workflow is part of an initial network setup, the service adds the local host to the cluster in the freshly initialized Cluster Store replica. If, instead, the workflow results from a reboot, the service loads the cluster configuration from the Cluster Store. The hostd is used by the service to update the cluster membership. In this example, the service represents an example of a privileged service with authority to make host level changes via the hostd APIs.

In some examples, (as depicted in FIG. 4D), when the bootstrap workflow is being performed as part of installation of new hosts, for example, the infravisor 110 discovers the cluster membership change (e.g., determines that a local host has been added), and caches the updated cluster membership set. In examples in which a single host is included in the cluster, this operation prevents re-initialization. In contrast, when multiple hosts are included in the cluster, this operation allows the cluster to reform without requiring a-priori knowledge of Cluster Store replica locations and active credentials.

In some examples, the watchdog component of the infravisor daemon combines several functions in the bootstrap logic including, discovery of existing infravisor runtimes accessible to the host, bootstrapping a new infravisor runtime when none is accessible to the host, and monitoring of an infravisor runtime after bootstrap or discovery to ensure it remains accessible. As watchdog is responsible for bringing up the initial clustering layer (infravisor etcd), the watchdog does not have a reliable mechanism to rely upon for a consistent view of the cluster or a view of the cluster state from other hosts. To compensate, all watchdogs in the cluster make independent decisions that are 1) assessed on the stability of a given decision, 2) made within time-bound windows, and 3) based on knowledge available to the local host (e.g., the ESX1 host). In some examples, the knowledge available is primarily datagram information received from other hosts in the same cluster.

In some of the examples, each of the watchdogs broadcast discovery (messages) datagrams over the infravisor overlay. These broadcast discovery datagrams double as a claim to bootstrap a new infravisor runtime. Hosts that receive a discovery broadcast can either 1) refute the claim to bootstrap and respond with a superior claim, whether for that host or as a proxy for a third host, or 2) accept the claim and wait for the claimant to bootstrap a runtime. For this to converge to a single runtime within the cluster, any host can determine a strict ordering from the content of one claim vs another claim. As used herein, claims are also referred to as votes. The architecture is only specific about this property (e.g., the ability to determine a strict ordering from the content of the claims) and need not address the precise content of a claim or versioning of claim logic within a cluster beyond that necessary to support upgrades.

In some examples, to support upgrades, an algorithm version used by an example host is included in any datagrams and recipient hosts consider the version information as significant data when determining bootstrap claims. Consequentially, among the set of responsive hosts, only those with the newest version of the bootstrap algorithm can bootstrap. This, in turn, limits the publishing of available service configurations for subsequent version selection to hosts with compatible etcd pod client versions.

With respect to decision stability, the discovery, bootstrap, and monitoring functions all collapse into a single property referred to as the “host local desired state of NodePorts for etcd and apiserver,” (also referred to as the infravisor desired state). For example, if the NodePort configuration for k8s datapath directs to the local host, it is implied that a k8s pod is to be running locally. If the k8s datapath directs to a different cluster member (i.e., a remote host), a k8s pod running is not to be running locally.

The role of watchdog is to ensure that pods are running within the partition. In some examples, watchdog achieves this by ensuring that the local system has connectivity to a running etcd pod and a Kubernetes pod (e.g., a k8s). In some examples, the watchdog ensures connectivity by manipulating NodePorts to direct traffic to local or remote pods. If the NodePorts configuration and the runtime states of local etcd pods and Kubernetes pods were independently managed (e.g., were managed by different systems), state races and unstable decisions would result. Making connectivity the goal, the NodePort configuration can be treated as the primary state and the desired state of the pods is derived from whether the NodePort targets local or remote endpoints.

In some examples, the watchdog uses NodePort configuration to determine whether k8s/etcd pods should be running on the host. If there's no etcd or k8s NodePort configured pointing to the local host, then the host should NOT be running those pods and they will be stopped if present. If there is a NodePort config pointing to the local host the pods will be started if not present.

Thus, a single piece of data (e.g., the NodePort config) determines both the datapath and whether the target of that datapath should be running to thereby avoid race states. If, instead, a flag or similar device, derived from NodePort config or otherwise, were used to determine if k8s pods should be running, then a potential state race could result in which NodePort indicates one thing, but the flag indicates another. Such a race should resolve over time, but in general should be avoided whenever possible.

In some examples, a host claiming the right to bootstrap the infravisor runtime, is entirely separated from a decision as to what Services specifications, and what versions of those specifications, are to be applied to the cluster. A decision regarding the services specifications, and respective versions thereof, is made once infravisor daemons have a common etcd pod with which to make consistent partition scoped decisions. As used in this context, the term “version” is narrower than that term is typically used when referring to software and includes any associated configuration applied to that service. Changing the configuration of a service by, for example, updating a value that gets placed into a ConfigMap, is treated in the same manner as deploying an update that uses a completely new version of the container image.

In some examples, the infravisor daemon for each host pushes the locally installed service specifications into the runtime etcd pod at a service granularity. If the same specification version is already present, the daemon instead records itself as a matching source for that version. When the service version installed on a given host is changed, the infravisor daemon on that same host will update its entry in the etcd pod. Additionally, some basic status about the daemon is pushed into the etcd pod to allow preference in subsequent voting. In some examples, the basic status information can identify that the daemon has connectivity with ClusterStore and includes a version number of the daemon. In some examples, the daemons use the etcd pod to elect a specific daemon that choses the service versions to apply, applies the necessary transforms, (e.g., translating FTT or enabled/disabled properties into a number of replicas needed), and applies the specifications to the runtime Kubernetes pods. Any number of selection strategies can be deployed to decide which of any available versions is to be selected, provided that the strategy provides a strict ordering.

In some examples, the infravisor 110 is required to be able to adopt pods without disrupting any workload running on the pods. The infravisor runtime is a support mechanism for running services within the cluster and not a critical path aspect of service operation. Further, the infravisor runtime is ephemeral and can be reconstructed at any time whether due to host failure, cluster lifecycle management, or otherwise.

To avoid disruption of Service workload, the infravisor 110 adopts unknown pods instead of killing (or disabling) the unknown pods. The option to adopt is made possible by the definition of the pods being stored outside of the infravisor runtime etcd pod. When a pod is reflected to the apiserver by spherelet and does not have a counterpart entry in the runtime, the pod is considered orphaned. When an orphaned pod is encountered, the infravisor controller schedules a new pod with the exact configuration of the reflected pod, the scheduler extender tells the apiserver that the pod was placed on the same spherelet as the reflecting the orphaned pod, a universally unique identifier (UUID) and a name of the orphaned pod are updated to match the newly scheduled pod and the newly scheduled pod takes the identity of the orphaned pod in the apiserver.

As described above, the spherelet is the source of truth for which pods are running, whereas the apiserver is the source of truth for what should be running. The apiserver instructs the spherelets as to which pods each spherelet should be running.

The spherelets tell the apiserver which pods they are running by “reflecting” the pod into the apiserver. In a normally operating k8s, if spherelet is running a pod that is not in the k8s set the apiserver instructed the spherelet to run, then spherelet will kill that pod. This would result in a service disruption when the infravisor runtime is recreated so by altering that behavior to allow pods to be adopted, such a service disruption is avoided.

Thus, the pod may still be killed after adoption, but it first gets reflected into the apiserver so there's an opportunity for it to be associated with desired state (e.g., if service A requires 3 replicas, and 2 pods are running serviceA, then 1 new serviceA pod is added).

In normal k8s operation, if the runtime was recreated, the existing 2 existing serviceA pods would be killed and then create 3 new ones would be created. By contrast, in infravisor 110 the smallest delta possible is applied to avoid service disruption.

Deployments (or similar) are associated with pods by selectors which can be dictated by a label match. The adopted pod will have labels per its initial configuration meaning it will become visible to any Deployment or otherwise managing that selection of pods. Scaling then occurs based on the configured replica counts and corresponding controller logic.

Some pods will not want to be adopted. For example, adopting a cluster control plane pod into a cluster with a different cluster ID has not value as the cluster control plane pod would need to entirely re-load its configuration. Thus, a pod can control whether it will be adopted by a cluster. In some examples, that a pod can express specific adoption preferences with match criteria that will apply when partitions heal. In some examples, an adoption preference can be indicated by annotations in the pod manifest/service specification.

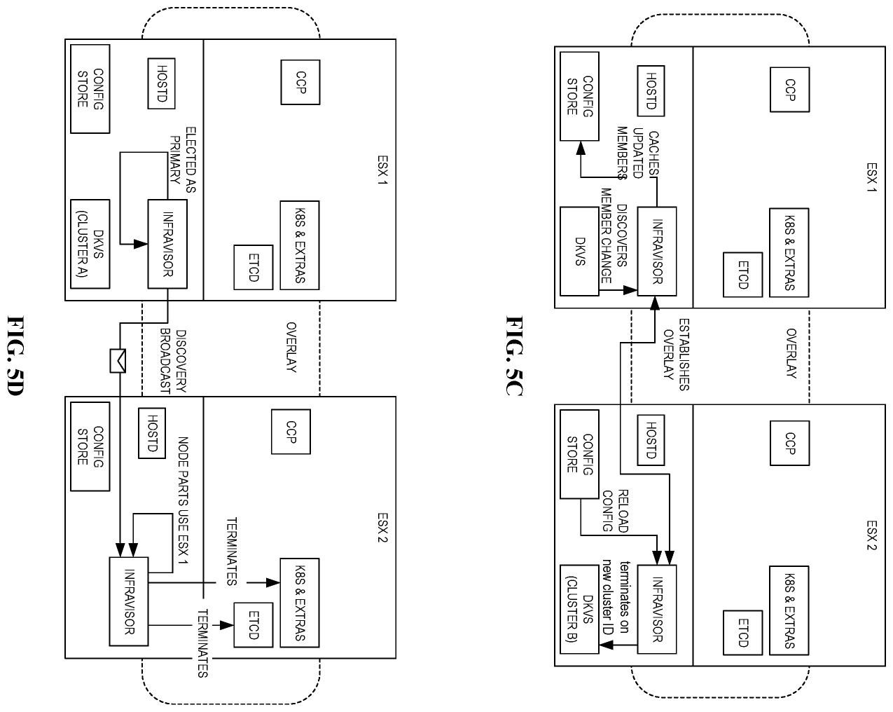

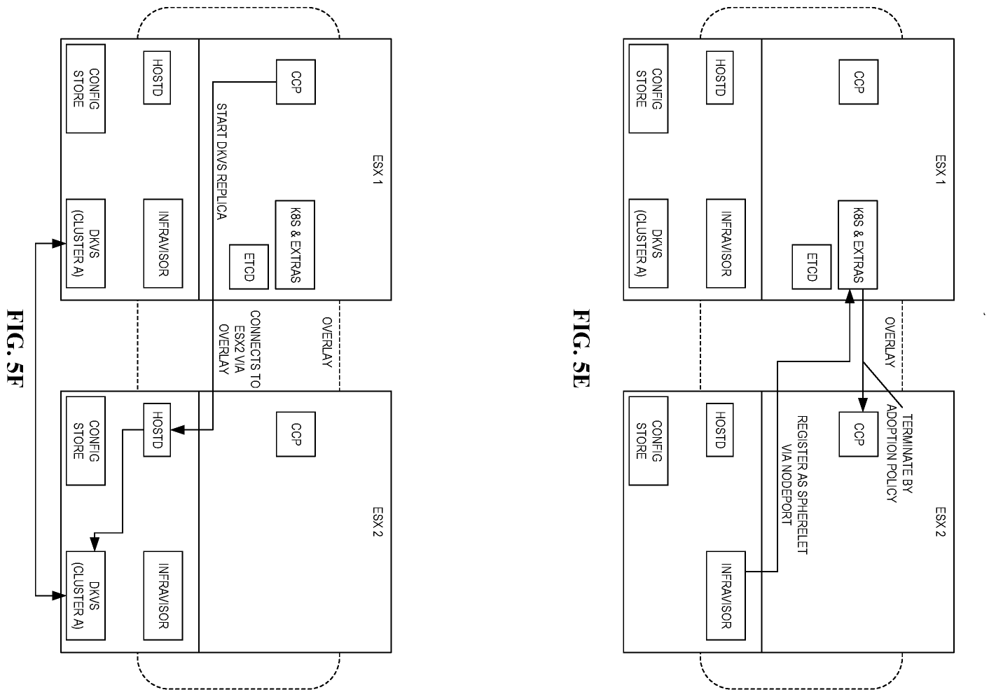

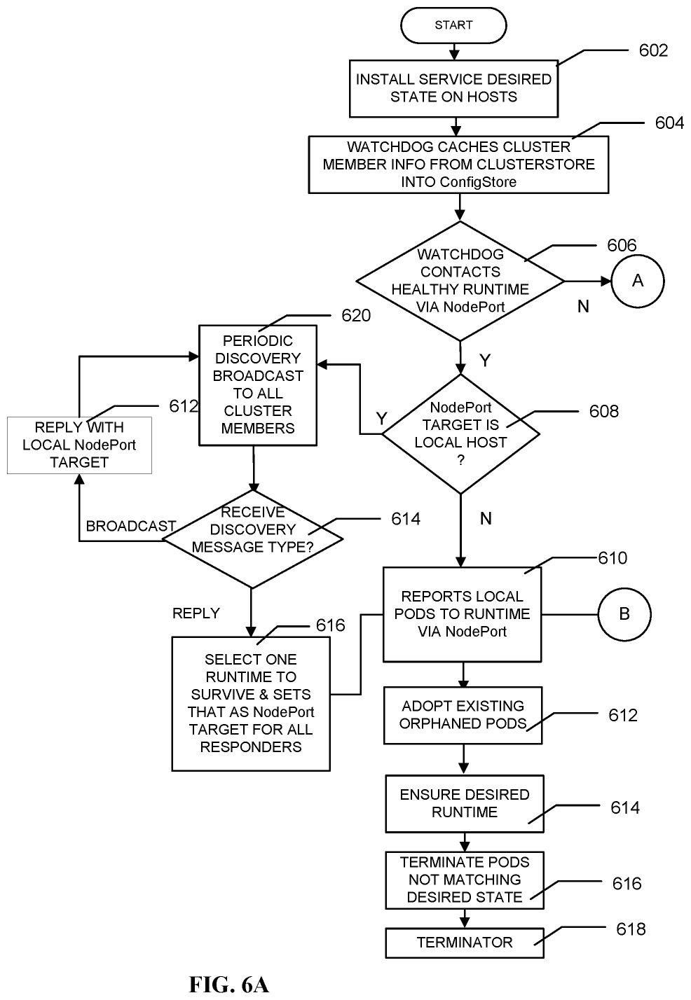

FIGS. 5A-5E are block diagrams illustrating a manner in which hosts join a cluster via infravisor 110. In FIG. 5A, both hosts are running Infravisor and presenting as single host clusters. Each host has an overlay configured, an initialized ClusterStore with a single replica, a Cluster Control Plane (CCP) service instance providing VM provisioning and cluster lifecycle management and the infravisor 110 is monitoring to maintain the current state.

In FIG. 5B, an admin authenticates with the CCP service on the first host (ESX1) and directs the first host to add the second host (ESX2) to the cluster. The CCP constructs: a “new joiner” bundle for the second host, which including making overlay shard assignments, (including an assignment for the second host), while persisting the assignment in Cluster Store, making connection info and trust bundle for existing the hosts in the cluster, and generating a cluster ID. The CCP on the first host makes a connection to hostd on the second host. In some examples, the connection is routed out of the overlay on the first host via the Egress to the management network and connects using administrator provided credentials for the second host. Next, the CCP invokes an “Add Host” operation on the second host which includes providing the second host with the new joiner bundle and receiving the second host connection information (IP and host certificate). In addition, the second host stores the contents of the new joiner bundle into the ConfigStore. Lastly, the CCP updates the cluster member list in Cluster Store with the second host connection information. In some examples, the information needed to construct a new joiner bundle is available via the environmental ConfigMaps.

In FIG. 5C, the second host joins the cluster. In some examples, the second host detects the change in ConfigStore, and the infravisor 110 running on the second host updates overlay configuration using the contents of the new joiner bundle (overlay shard assignments and trust roots), joining the first host overlay. In some examples, the infravisor 110 running on the second host terminates the current Cluster Store instance because it is associated with a cluster ID not the one loaded from ConfigStore.

In FIG. 5D, either of the first host or the second host initiates an infravisor discovery broadcast to configure NodePorts. This operation can include 1) sending a discovery broadcast to all overlay hosts, 2) deciding which host shall be primary (in this example the first host is selected), the second host Infravisor reconfiguring NodePorts to connect with the etcd and the apiserver on the first host, and 3) terminating the etcd and the apiserver on the second host because they are no longer targets of the active NodePort configuration.

In FIG. 5E, the second host becomes a node of Kubernetes on the first host. In some examples, this operation includes the spherelet of the second host connecting to the localhost, now routing to the first host, and registering itself as a node. Next, the Kubernetes applies adoption policy to pods running on second host which includes directing the CCP on the second host to self-terminate due to the configured Service policy.

In FIG. 5F, the Cluster Store manager in the CCP determines that a new replica should be placed on the second host which includes the CCP connecting to the second host via the overlay, and the CCP calling the Cluster Store API on the second host to create a replica peering with the first host replica.

While example manners of implementing an infravisor 110 are illustrated in FIGS. 1, 2, 3, 4A-4E, 5A-5F, one or more of the elements, processes, and/or devices illustrated in the FIGS. may be combined, divided, re-arranged, omitted, eliminated, and/or implemented in any other way. Further, the components of the infravisor 110 illustrated in FIGS. 1, 2, 3, 4A-4E and 5A-5F, may be implemented by hardware alone or by hardware in combination with software and/or firmware. Thus, for example, any of the components of the FIGS. Example 1, 2, 3, 4A-4E, 5A-5F could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example infravisor 110 may include one or more elements, processes, and/or devices in addition to, or instead of, those illustrated in FIGS. 1, 2, 3, 4A-4E, 5A-5F and/or may include more than one of any or all of the illustrated elements, processes and devices.

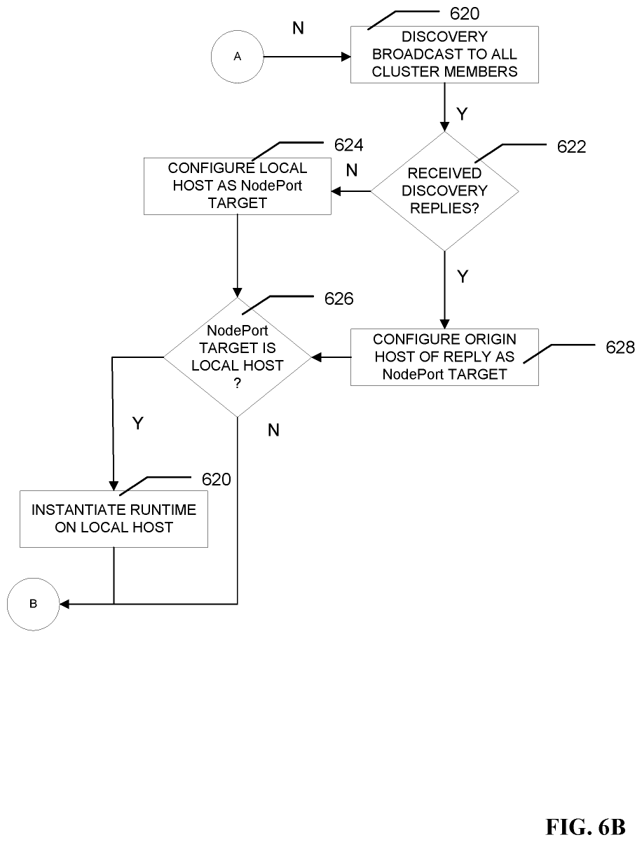

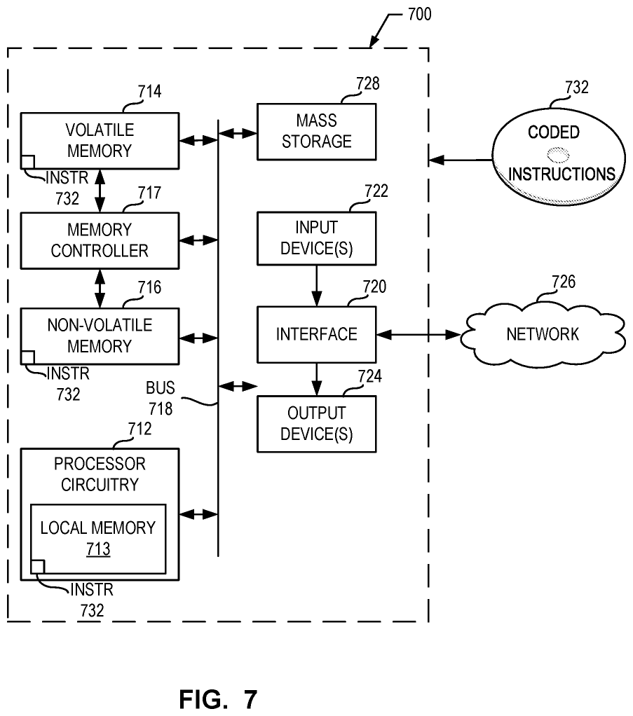

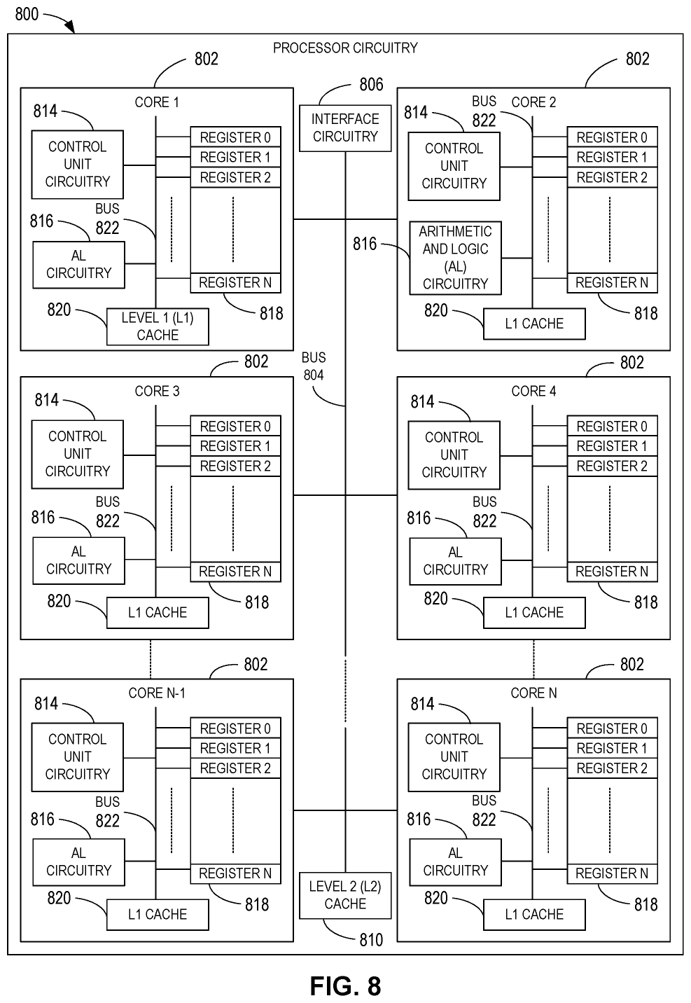

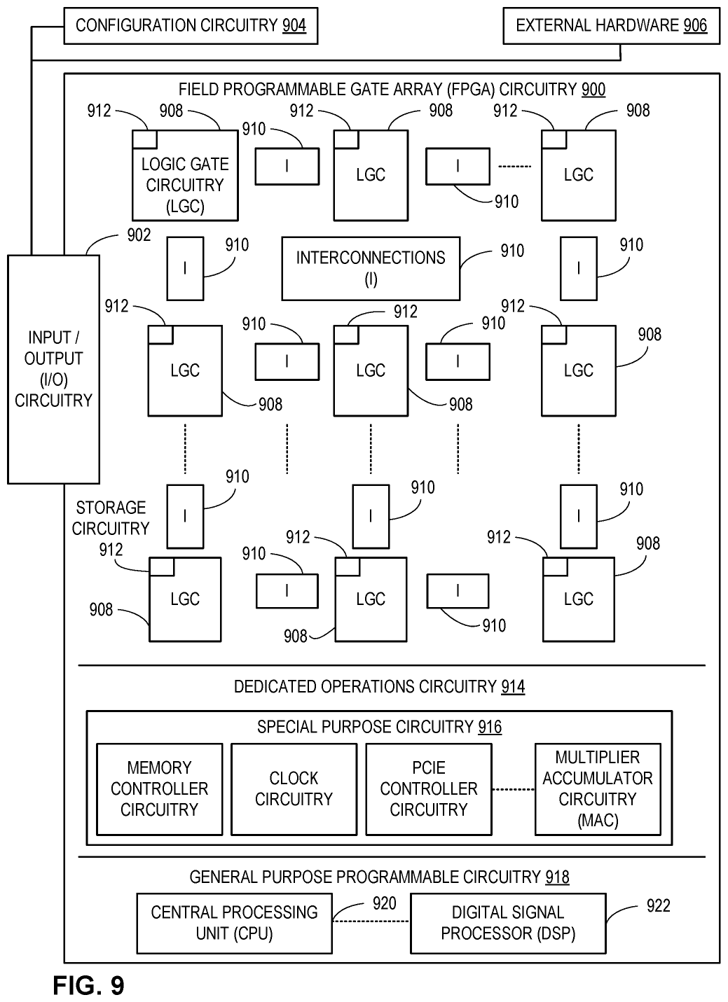

A flowchart representative of example machine readable instructions, which may be executed to configure processor circuitry to implement the infravisor 110 is shown in FIG. 7 (to be added). The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 6, many other methods of implementing the example infravisor 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to insert high level goal of flowchart. The machine readable instructions and/or the operations 600 of FIG. 6 begin at block 602, at which a service desired state is installed onto hosts of a cluster. At a block 604, the watchdog of the infravisor 110 (see FIG. 1) operates to cache cluster member information from the Cluster Store into in CONFIGSTORE storage. In some examples, the cluster members can be hosts implemented as ESXi or ESX servers having images and specifications stored in a host storage. In some examples, the images include images and binaries for an infravisor. In some examples, a desired cluster state is also stored in the CONFIGSTORE storage of each of the hosts. At a block 606, the infravisor watchdog attempts to contact a healthy infravisor runtime via the NodePort. If, at the block 606 a healthy infravisor runtime is contacted, at a block 608, the watchdog determines if the NodePort target is the local host of the watchdog. If the watchdog determines that the NodePort target is not the local host, the spherelet reports local pods to runtime via NodePort at a block 610. At a block 612, the infravisor runtime adopts any existing orphaned pods and the watchdog ensure that a desired state is installed in the contacted infravisor runtime at a block 614. At a block 616, any pods not matching a desired state are terminated at a block 618 by a terminator device 626. In some examples, the terminator device is any one of the infravisor devices or any other network cluster device that causes the pods to be terminated.

If, at the block 608, the watchdog determines that the NodePort target is the local host, at a 620, the net-agent or watchdog periodically broadcasts a discovery message to all cluster members. If the type of message received is a broadcast message, as determined at a block 614, the watchdog replies to the messages with the local NodePort target. If the type of message received at the block 614 is instead a reply to the broadcast message, the watchdogs of the hosts in communication select one infravisor runtime to survive and sets that NodePort target for all host responders. After setting the NodePort target, the flowchart returns to the block 610 and the blocks subsequent thereto as describe above.

In some examples, at the block 606, a healthy infravisor runtime is not contacted. In some examples, the flowchart continues to a block 620 (see the tag A on FIG. 6B) at which a discovery broadcast message is sent to all cluster members. At a block 622, the watchdog determines whether any replies were received in response. If not, at a block 624, the watchdog configures the local host as the NodePot target. Thereafter, at a block 626 the watchdog determines whether the NodePort target is the local host. If at the block 622, a reply to the discovery broadcast is received, the watchdog configures the origin host of the reply as the NodePort Target at a block 628. At a block 626, the watchdog tests to determine whether the NodePort target is the local host. If so, the local host instantiates an infravisor runtime and thereafter the flowchart continues to the block 610 of FIG. 6A as indicated by the tag B. If the NodePort target is not the local host, the flowchart continues to the block 610 of FIG. 6A as indicated by the tag B flowchart.

FIG. 7 is a block diagram of an example processor platform 800 structured to execute and/or instantiate the machine readable instructions and/or the operations of FIG. 6 to implement the apparatus of FIGS. 1, 2, 3, 4A-4E, 5A-5F. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements any of the components of the infravisor 110.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIG. 6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowchart of FIG. 7 to effectively instantiate the circuitry of FIGS. 1, 2, 3, 4A-4E, and 5A-5D as logic circuits to perform the operations corresponding to those machine readable instructions. In some such examples, the circuitry of FIGS. 1, 2, 3, 4A-4E, and 5A-5F is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 7.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 700 of FIG. 7 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowchart of FIG. 7 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowchart of FIG. 7. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowchart of FIG. 7. As such, the FPGA circuitry 900 may be structured to effectively instantiate some or all of the machine readable instructions of the flowchart of FIG. 7 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 7 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 700 of FIG. 7. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIG. 7 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modem FPGA circuitry may include an on-board CPU, such as one or more of the example CPU 920 of FIG. 9. Therefore, the processor circuitry 712 of FIG. 7 may additionally be implemented by combining the example microprocessor 900 of FIG. 9 and the example FPGA circuitry 900 of FIG. 9. In some such hybrid examples, a first portion of the machine readable instructions represented by the flowchart of FIG. 7 may be executed by one or more of the cores 902 of FIG. 9, a second portion of the machine readable instructions represented by the flowchart of FIG. 7 may be executed by the FPGA circuitry 900 of FIG. 9, and/or a third portion of the machine readable instructions represented by the flowchart of FIG. 6 may be executed by an ASIC. It should be understood that some or all of the circuitry of FIGS. 1, 2, 3, 4A-4E and 5A-5F may, thus, be instantiated at the same or different times. Some or all of the circuitry may be instantiated, for example, in one or more threads executing concurrently and/or in series. Moreover, in some examples, some or all of the circuitry of FIGS. 1, 2, 3, 4A-4E and 5A-5F may be implemented within one or more virtual machines and/or containers executing on the microprocessor.

In some examples, the processor circuitry 712 of FIG. 7 may be in one or more packages. For example, the microprocessor 900 of FIG. 9 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that allow a cluster of compute devices to continue operating even in the event that quorum is lost. Disclosed systems, methods, apparatus, and articles of manufacture improve the efficiency of using a computing device by allowing services supplied by cluster compute devices to continue to be supplied after failure of one of the compute device occurs even when the failed compute device causes a loss of quorum. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
machine readable instructions; and
processor circuitry to at least one of instantiate or execute the machine readable instructions to:
identify member nodes of a cluster;
determine whether an instance of an infrastructure supervisor is operating on any of the nodes;
when an infrastructure supervisor is determined to not be operating, instantiate an infrastructure supervisor; and
broadcast a discovery message to other nodes.

2. The apparatus of claim 1, wherein the processor circuitry is further to:
identify replies to the discovery message from other nodes;
determine one of the other nodes is to instantiate the infravisor runtime based on the replies to the discovery message from other nodes.

3. A non-transitory machine readable storage medium comprising instructions that, when executed, cause processor circuitry to at least:
identify member nodes of a cluster;
determine whether an instance of an infrastructure supervisor is operating on any of the nodes;
when an infrastructure supervisor is determined to not be operating, instantiate an infrastructure supervisor; and
broadcast a discovery message to other nodes.

4. The non-transitory machine readable storage medium of claim 3 wherein the instructions further cause the processor circuitry to:
identify replies to the discovery message from other nodes;
determine one of the other nodes is to instantiate the infravisor runtime based on the replies to the discovery message from other nodes.

5. A method comprising:
identifying, by executing an instruction with one or more processors, member nodes of a cluster;
determining, by executing an instruction with one or more processors, whether an instance of an infrastructure supervisor is operating on any of the nodes;
instantiating, by executing an instruction with one or more processors, an infrastructure supervisor, when an infrastructure supervisor is determined to not be operating; and
broadcasting, by executing an instruction with one or more processors, a discovery message to other nodes.

6. The method of apparatus of claim 1, wherein the processor circuitry is further to:
identify replies to the discovery message from other nodes;
determine one of the other nodes is to instantiate the infravisor runtime based on the replies to the discovery message from other nodes.
